(19) United States
(12) Patent Application Publication
(10) Pub. No.: US 2022/0396239 A1
(43) Pub. Date: Dec. 15, 2022

(54) WHEEL IMMOBILIZER

(71) Applicant: John Clarke, Burnaby (CA)

(72) Inventor: John Clarke, Burnaby (CA)

(21) Appl. No.: 17/827,935

(22) Filed: May 30, 2022

Related U.S. Application Data
(60) Provisional application No. 63/210,772, filed on Jun. 15, 2021.

(51) Int. Cl. B60R 25/09

(52) U.S. Cl. CPC B60R 25/093

(57) ABSTRACT

A wheel immobilizer has a plurality of C-shaped members extendable about the wheel, including a telescopic member that is lockable in place. A unit connector and a wheel fastener cover are shaped to extend about fasteners of the wheel. The unit connector includes a threaded member and is shaped to enable macro and micro adjustments of the extent to which the wheel fastener cover extends from the C-shaped members. Slots of the unit connector enable the wheel immobilizer to couple together within a plane in a storage position. Projections of the wheel immobilizer inhibit rotation of the wheel and are tuned to make a noise when rotation of the wheel is attempted. An elongate round member is positioned within the telescopic member and configured to inhibit cutting therethrough. C-shaped members are rotatably coupled together via detent mechanisms the tension of which is adjusted via set screws which are externally accessible.

### CROSS REFERENCE TO RELATED APPLICATIONS

This application is a non-provisional of U.S. Provisional Patent Application No. 63/210,772 filed in the United States Patent and Trademark Office on 15 Jun. 2021, and the disclosure of which is incorporated herein by reference and priority to which is claimed.

### BACKGROUND OF THE INVENTION

### Field of the Invention

There is provided an immobilizer. In particular, there is provided a wheel immobilizer.

### Description of the Related Art

U.S. Pat. No. 5,333,477 to Davis discloses a lightweight vehicle immobilization device to prevent theft of a vehicle or to prevent driving of the vehicle by its owner. The device has a hub shield, an adjustable arm, a upper arm and a lower arm. Each of the arms has ends which are adapted to traverse the tread of a tire of the vehicle and engage the inside of the tire so as to prevent removal of the device when the device is adjusted to the circumference of the tire. The device includes means on the hub shield to limit the degree of outward rotation of the upper and lower arm to about 120 degrees when engaged on the tire. The device includes a wedge shaped member having two surfaces which are about 120 degrees from each other. The wedge shaped member is adapted to slide on the adjustable arm and, when locked in position, may function to prevent inward rotation of the upper arm and the lower arm and to prevent movement of the adjustable arm.

U.S. Pat. No. 7,107,802 to Clarke discloses an immobilization apparatus for a vehicle having a wheel with a tire. The apparatus comprises first and second elongated members having inner ends and outer ends. The inner ends are connected together and the outer ends are angularly spaced apart. There is an C-shaped clasp at each of the outer ends for grasping the tire. The clasps are rotatable about the outer ends. A third elongated member has an inner portion and an outer portion and is angularly spaced-apart from the first and second members. The inner portion is tubular and the outer portion of the third elongated member is telescopically received therein. The outer portion has an C-shaped clasp, and the outer portion is rotatable with respect to the inner portion. A locking mechanism secures the outer portion at a fixed telescopic position with respect to the inner portion of the third elongated member.

### BRIEF SUMMARY OF INVENTION

There is provided, and it is an object to provide, an improved wheel immobilizer.

There is accordingly provided a wheel immobilizer according to a first aspect. The wheel immobilizer includes a plurality of joined together elongate members. The elongate members have angularly spaced-apart outer ends to which C-shaped clasps couple thereto. One of the C-shaped clasps telescopically couples to one said elongate member and is lockably positioned in place thereafter. The wheel immobilizer includes a wheel fastener cover shaped to extend about fasteners of a wheel. The wheel immobilizer includes a unit connector. The unit connector has a first end which couples to the wheel fastener cover and a second end shaped to be received within a slot of at least one of the elongate members. The wheel immobilizer includes a threaded member threadably coupled to the second end of the unit connector. The threaded member is disposed within the slot of the at least one of the elongate members. Threaded adjustment of the threaded member enables adjustment of the extent to which the wheel fastener cover extends from the at least one of the elongate members.

There is also provided a wheel immobilizer according to a second aspect. The wheel immobilizer includes a plurality of joined together elongate members. The elongate members have angularly spaced-apart outer ends to which C-shaped clasps couple thereto. One of the C-shaped clasps telescopically couples to one said elongate member and is lockably positioned in place thereafter. The wheel immobilizer includes a wheel fastener cover shaped to extend about fasteners of a wheel. The wheel immobilizer includes a unit connector. The unit connector has a pair of sides spaced-apart by a first distance and a pair of ends extending between and perpendicular to said sides. The ends of the unit connector are spaced-apart by a second distance which is smaller than the first distance. When less space is needed between the elongate members and the wheel fastener cover, a first said end of the unit connector couples to the wheel fastener cover and a second said end of the unit connector is shaped to be received within a slot of at least one said elongate member. When the extent to which the wheel fastener cover extends from the elongate members needs increasing, a first said side of the unit connector couples to the wheel fastener cover and a second said side of the unit connector is shaped to be received within the slot of the at least one said elongate member.

There is further provided a wheel immobilizer according to a third aspect. The wheel immobilizer includes a plurality of joined together elongate members. The elongate members have angularly spaced-apart outer ends to which C-shaped clasps couple thereto. One of the C-shaped clasps telescopically couples to one said elongate member and is lockably positioned in place thereafter.

The wheel immobilizer includes a wheel fastener cover shaped to extend about fasteners of a wheel. The wheel immobilizer includes an adjustment member having a first position via which the wheel fastener cover couples to the elongate members. The adjustment member has a second position via which the wheel fastener cover couples to the elongate members and extends therefrom to a greater extent than said first position.

There is yet further provided a wheel immobilizer according to a fourth aspect. The wheel immobilizer includes a plurality of joined together elongate members. The elongate members have angularly spaced-apart outer ends to which C-shaped clasps couple thereto. One of the C-shaped clasps telescopically couples to one said elongate member. The elongate members and C-shaped clasps are shaped to partially extend about treading and an inner sidewall of the wheel and lockably positioned in place thereafter. The wheel immobilizer includes a wheel fastener cover shaped to extend about fasteners of a wheel and couple to the elongate members. The wheel immobilizer includes one or more projections coupled to and extend outwards from one or more said C-shaped clasps. The one or more projections inhibit rotation of the wheel and are tuned to make a noise when rotation of the wheel is attempted.

There is yet also provided a wheel immobilizer according to a fifth aspect. The wheel immobilizer includes a pair of joined together elongate members, with spaced-apart outer ends thereof to which C-shaped clasps couple. The wheel immobilizer includes a fixed tubular member coupled to and angularly spaced from the elongate members. The wheel immobilizer includes an adjustment tubular member telescopically received within and adjustable relative to the fixed tubular member. A further C-shaped clasp couples to the adjustment tubular member via an outer end thereof. The C-shaped clasps are shaped to partially extend about treading and an inner sidewall of the wheel and be lockable in place thereafter. The wheel immobilizer includes an elongate round member positioned within and freely rotatable relative to the adjustment tubular member.

There is yet additionally provided a wheel immobilizer according to a sixth aspect. The wheel immobilizer includes a pair of joined together elongate members, with spaced-apart outer ends thereof. The wheel immobilizer includes a pair of C-shaped clasps with respectively cylindrical members coupled thereto and extending outwards therefrom. Each said cylindrical member has a radially inwardly extending annular groove. Each said cylindrical member has one or more indentations positioned within and extending radially inwards from the annular groove thereof. The outer ends of the elongate members are shaped to receive respective said cylindrical members therein. The elongate members rotatably couple to the C-shaped clasps via respective detent mechanisms coupled thereto. The detent mechanisms include end members, such as balls, which are spring-biased to extend within the respective said annular grooves and selectively fit respective said indentations to selectively inhibit rotation of the C-shaped clasps relative to the elongate members. The wheel immobilizer includes a fixed tubular member coupled to and angularly spaced from the elongate members. The wheel immobilizer includes an adjustment tubular member telescopically received within and adjustable relative to the fixed tubular member. A further C-shaped clasp couples to the adjustment tubular member via an outer end thereof. The C-shaped clasps are shaped to partially extend about treading and an inner sidewall of the wheel and be lockable in place thereafter.

There is also provided a detent mechanism. The detent mechanism includes a chamber having a primary bore extending from a first end thereof towards a second end thereof. The detent mechanism includes a second bore extending from the second end thereof towards the first end thereof. The primary bore extends radially outwards from and is in fluid communication with the second bore. The detent mechanism includes a threaded member threadably coupled to the chamber via the primary bore. The detent mechanism includes an end member slidably positioned at least partially within and adjacent to the first end of the chamber. The detent mechanism includes a resilient member positioned between the threaded member and the end member. The threaded member is externally accessible via the second bore, with adjustment thereof enabling adjustment of the extent to which the resilient member biases the end member outwards from the chamber.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is an outer side perspective view of a wheel immobilizer according to one aspect, the immobilizer extending about a wheel, the immobilizer including a pair of angularly spaced-apart elongate members with C-shaped clasps coupled thereto via a detent mechanism, with the C-shaped clasps being shown in a deployed position, and the immobilizer further including a fixed tubular member coupled to and angularly spaced from the elongate members, an adjustable member telescopically received within and adjustable relative to the fixed tubular member, and a locking mechanism which selectively locks positioning of the adjustable member;

FIG. 2 is an inner side, bottom perspective view of the immobilizer of FIG. 1;

FIG. 3 is a longitudinal sectional view of one of the detent mechanisms of the wheel immobilizer of FIG. 1 coupling together one of the elongate members and C-shaped clasps of the wheel immobilizer of FIG. 1, with the elongate member and C-shaped clasp being shown in fragment;

FIG. 4 is a longitudinal sectional view of the locking mechanism of FIG. 1 shown in a locked position and coupling together with the fixed tubular member and the adjustable member of FIG. 1, with the fixed tubular member being shown in fragment, and with the wheel immobilizer further including an elongate round member disposed within the adjustable member;

FIG. 5 is an outer side, rear, bottom perspective view of a wheel fastener cover, a connector block and a threaded member of the wheel immobilizer of FIG. 1, with the threaded member coupling to and extending outwards from a first end of connector block in an extended position, and with connector block being shown in a first, lowered and centered position;

FIG. 6 is an outer side, front, top perspective view thereof;

FIG. 7 is a longitudinal sectional view of the wheel fastener cover and the connector block of FIG. 5, with the wheel fastener cover adjacent to and in the process of extending about wheel fasteners of a wheel shown in fragment, with the wheel fastener cover shown abutting the fixed tubular member of the wheel immobilizer of FIG. 1, with the threaded member being shown removed, with the connector block shown in the first, lowered position within a slot of the fixed tubular member, and with the fixed tubular member and adjustable member therewithin being shown in fragment;

FIG. 8 is a longitudinal sectional view similar to FIG. 7, further including the threaded member coupled to and extending outwards from the first end of the connector block, the threaded member being in the extended position so as to abut a wall of the fixed tubular member within the slot and bias the wheel fastener cover via the connector block to snugly abut the wheel, with the wheel, fixed tubular member and adjustable member being shown in fragment;

FIG. 9 is an inner side perspective view of the wheel immobilizer of FIG. 1, with the wheel immobilizer being shown in a stored position in which the C-shaped clasps and the adjustable member are aligned within a plane;

FIG. 10 is a longitudinal sectional view of the wheel fastener cover in the stored position of the wheel immobilizer of FIG. 9, with the connector block in the first, lowered position within the slot of the fixed tubular member, with a first slot at a first side of the connector block fitting within a wall portion of the fixed tubular member, and with the threaded member coupling to and extending outwards from a second side of the connector block, the threaded member abutting the fixed tubular member and being adjusted to enable the connector block to snugly fit within the slot and couple to the fixed tubular member in the stored position so that the connector block cannot be removed without unlocking and retracting the adjustable member;

FIG. 11 is an outer side, rear, bottom perspective view of the wheel fastener cover, the connector block and the threaded member of the wheel immobilizer of FIG. 1 arranged similar to FIG. 5, with the connector block being shown in a second, lowered and off-center position;

FIG. 12 is an outer side, rear, bottom perspective view of the wheel fastener cover, the connector block and the threaded member of the wheel immobilizer of FIG. 5, with the threaded member coupling to and extending outwards from the first side of the connector block in a retracted position, and with connector block being shown in a third, elevated position;

FIG. 13 is an outer side, front, top perspective view thereof;

FIG. 14 is a longitudinal sectional view the wheel fastener cover and the connector block of FIG. 12, with the wheel fastener cover adjacent to and in the process of extending about wheel fasteners of the wheel shown in fragment, with the threaded member being shown removed, with the connector block shown in the third, elevated position within the slot of the fixed tubular member, and with the fixed tubular member and adjustable member therewithin being shown in fragment;

FIG. 15 is a longitudinal sectional view similar to FIG. 14, further including the threaded member coupled to and extending outwards from the first side of the connector block, the threaded member being in the extended position so as to abut the wall of the fixed tubular member within the slot and bias the wheel fastener cover via the connector block to snugly abut the wheel, with the wheel, fixed tubular member and adjustable member being shown in fragment;

FIG. 16 is a longitudinal sectional view of the wheel fastener cover in the stored position of the wheel immobilizer of FIG. 9, with the connector block positioned in the third, elevated position seen in FIG. 12, the connector block being positioned within the slot of the fixed tubular member seen in FIG. 16, the connector block having a second slot at the first end thereof, the second slot of the connector block fitting within the wall portion of the fixed tubular member, and the threaded member coupling to and extending outwards from a second end of the connector block, the threaded member abutting the fixed tubular member and being adjusted to enable the connector block to snugly fit within the slot of the connector block, the connector block coupling to the fixed tubular member in the stored position thereby; and

FIG. 17 is an outer side, rear, bottom perspective view of the wheel fastener cover, the connector block and the threaded member of the wheel immobilizer of FIG. 12, with the threaded member coupling to and extending outwards from the first side of the connector block in a retracted position, and with connector block being shown in a fourth, elevated position.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

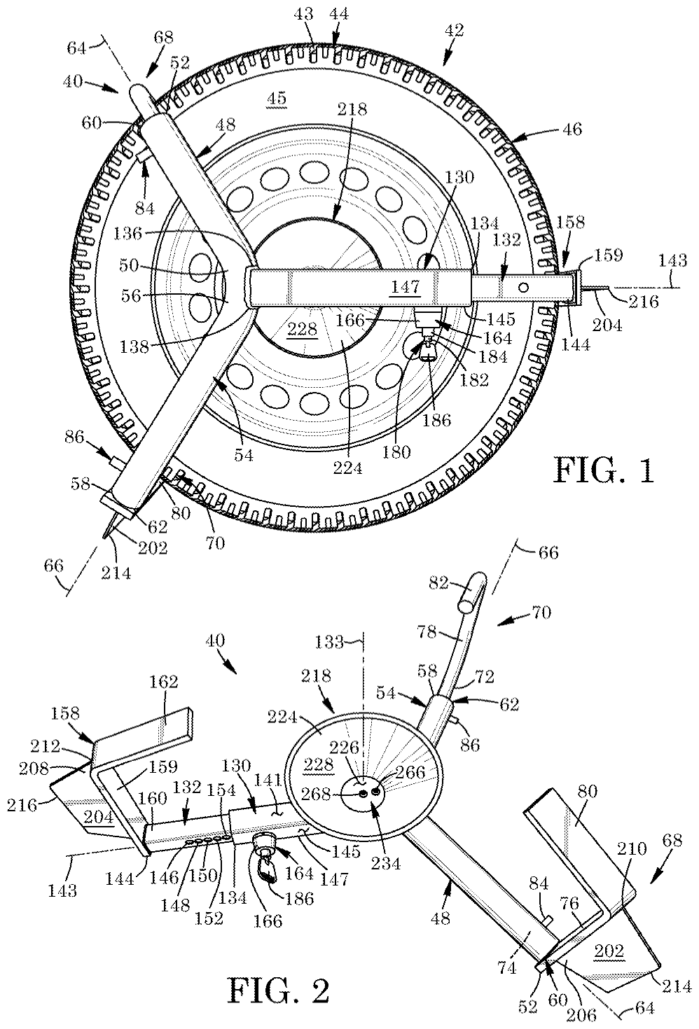

Referring to the drawings and first to FIG. 1, there is shown a wheel immobilizer 40 to be installed on a wheel 42 and tire 44 of a vehicle 46.

The wheel immobilizer includes a first elongate member 48 having an inner end 50 and an outer end 52. The wheel immobilizer includes a second elongate member 54 having an inner end 56 and an outer end 58. Each elongate member is tubular in this example; however, this is not strictly required and the elongate members may be non-tubular in other embodiments. Inner ends 50 and 56 of first elongate member 48 and second elongate member 54 are joined together and form an integrated whole in this example; however here too this is not strictly required. Outer ends 52 and 58 of the first elongate member and the second elongate member are angularly spaced-apart from each other by an obtuse angle; however, this is not strictly required. The elongate members have openings 60 and 62, respectively, extending therein near outer ends 52 and 58 thereof. Elongate members 48 and 54 extend along longitudinal axes 64 and 66, respectively.

As seen in FIG. 2, wheel immobilizer 40 includes a first C-shaped clasp 68 and a second C-shaped clasp 70. The C-shaped clasps rotatably couple to elongate members 48 and 54 via first elongate portions 72 and 74 which are shaped to fit within and extend outwards from openings 60 and 62 of elongate members 48 and 54. C-shaped clasps 68 and 70 include second elongate portions 76 and 78 extending outwards from the first elongate portions thereof and extending laterally outwards from axes 64 and 66. The C-shaped clasps include third elongate portions, in this example bent end portions 80 and 82 coupled and extending angular outwards from second elongate portions 76 and 78, respectively.

As seen in FIG. 1, wheel immobilizer 40 includes a pair of connection mechanisms 84 and 86 via which each C-shaped clasp rotatably couple to a respective said elongate member. Each of the connection mechanisms is substantially the same and accordingly only connection mechanism 86 will be described in detail.

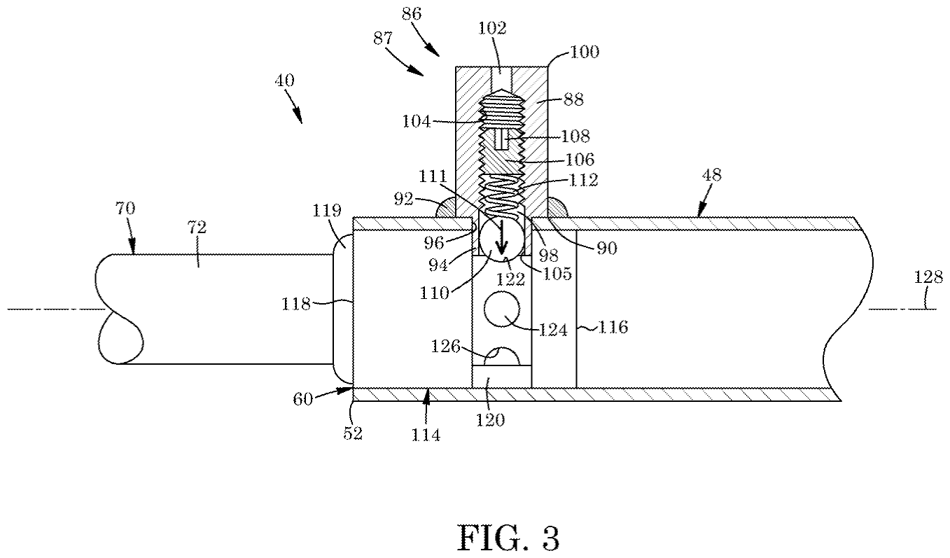

As seen in FIG. 3, connection mechanism 86 includes an end protrusion, in this example a cylindrical member 114 shaped to be received within opening 60 at outer end 58 of elongate member 48. Each cylindrical member has an inner end 116 and an outer end 118 aligned with outer end 52 of elongate member 48. The outer end of each cylindrical member 114 couples to a corresponding C-shaped clasp 70 via welding 119 in this example; however, this is not strictly required. Each cylindrical member has a radially inwardly-extending annular groove 120 near the inner end thereof in this example. Each cylindrical member 114 includes one or more, in this example four indentations 122, 124 and 126 in the form of conical holes that are spaced 90 degrees increments along the annular groove. The indentations are positioned within and extend radially inwards from groove 120 of cylindrical member 114.

Elongate member 48 and corresponding cylindrical member 114 so received within the elongate member have a common axis 128. Opening 60 of the elongate member is positioned to align with annular groove 120 when cylindrical member 114 is received within outer end 52 of its corresponding elongate member.

As seen in FIG. 3, cylindrical member 114 is secured to the elongate member via a detent mechanism 87. Each detent mechanism includes a housing or chamber 88 that is tube-shaped in this example. The chamber is adjacent or near outer end 52 of elongate member 48 in this example. Chamber 88 has a first or proximal end 90 that couples to corresponding elongate member 48, in this example via welding 92; however, this is not strictly required. The chamber is thus non-removably coupled to the elongate member, in this example via welding.

Chamber 88 includes a sleeve portion 94 coupled to and extending outwards from the proximal end thereof. The sleeve portion is shaped to fit within a corresponding aperture 96 within elongate member 48 and extends about a first or proximal bore 98 of chamber 88. Sleeve portion 94 of chamber 88 has an inner wall 105 which is smooth.

The chamber has a second or distal end 100 spaced-apart from proximal end 90 thereof and a second or distal bore 102 extending from the distal end towards the proximal end thereof. The distal bore is shaped to receive an adjustment tool, in this example a hex key (not shown) therethrough. Chamber 88 has a third or central bore 104 which is threaded in this example and which is in fluid communication with bores 98 and 102. The central bore is between inner wall 105 of sleeve portion 94 and bore 102 in this example. First bore 98 and central bore 104 may be referred to as a primary bore, with the central bore being a threaded portion of the primary bore.

Detent mechanism 87 includes an adjustable member or threaded member, in this example a set screw 106 positioned within chamber 88 and threadably coupled to central bore 104. The set screw is positioned in place via proximal bore 98 which is shaped to receive the set screw therethrough. Distal bore 102 is shaped to inhibit the set screw from passing therethrough. The set screw has a socket head 108 facing and in fluid communication with distal bore 102.

Detent mechanism 87 includes a resiliently outwardly-biased end member, in this example an at least partially spherical member, in this case a ball 110 shaped to slidably fit within proximal bore 98. The detent mechanism further includes a resilient member, in this example a coil spring 112 positioned within central bore 104. The coil spring is disposed between set screw 106 and ball and is configured to bias the ball outwards from chamber 88 in a downward direction, from the perspective of FIG. 3 and as shown by arrow 111. The distal bore 102 has a diameter smaller than that of ball 110 and coil spring 112 and is shaped to inhibit the ball and spring from passing therethrough in this example.

Adjustment of set screw 106 adjusts the extent to which the ball is biased outwards from sleeve portion 94 of chamber 88. Ball 110 is configured to engage, fit within, and be moveable about annular groove 120 of cylinder member 114 in this example. The ball is moveable from a retracted position, in which the ball is positioned largely within sleeve portion 94, to an extended position in which the ball extends outwards from the sleeve portion to a greater extent compared to the retracted position. Referring to FIG. 3, detent mechanism 87 as herein described may thus enable tensioning of spring 112 and ball 110 to be adjustable via set screw 106 that can be externally accessed through bore 102 and socket head 108. The detent mechanism as herein described may thus be periodically adjusted, and thereby account for wear and/or loss of spring tension over time.

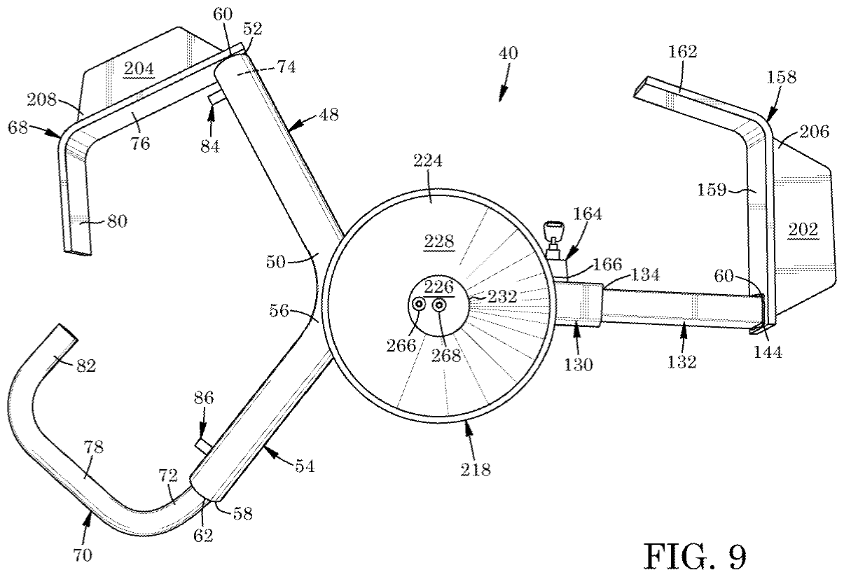

Balls 110 are thus spring-biased to extend within respective annular grooves 120 of cylindrical members 114 and fit within respective indentations 122, 124 and 126 of the cylindrical members to selectively inhibit rotation of C-shaped clasps 70 relative to the first and second elongate members 48. Chamber 88 is thus positioned to enable C-shaped clasp 70 and cylindrical member 114 to rotate relative to its corresponding elongate member 48. Chamber 88 so coupled and positioned inhibits removal of cylindrical member 114 from elongate member 48 in this example. Thus, the connection mechanism in this example is shaped to inhibit removable of the C-shaped clasps. Wheel immobilizer 40 is in the stored position when first elongate member 48, second elongate member 54 and C-shaped clasps 68 and 70 thereof are rotated to align within a plane as seen in FIG. 9. The C-shaped clasps are moveable from the stored position seen in FIG. 9 to deployed or lock positions seen in FIGS. 1 to 2. To move the C-shaped clasps from the deployed positions to storage positions and vice versa, the operator selectively taps/pushes on C-shaped clasps 68 and 70 thereof.

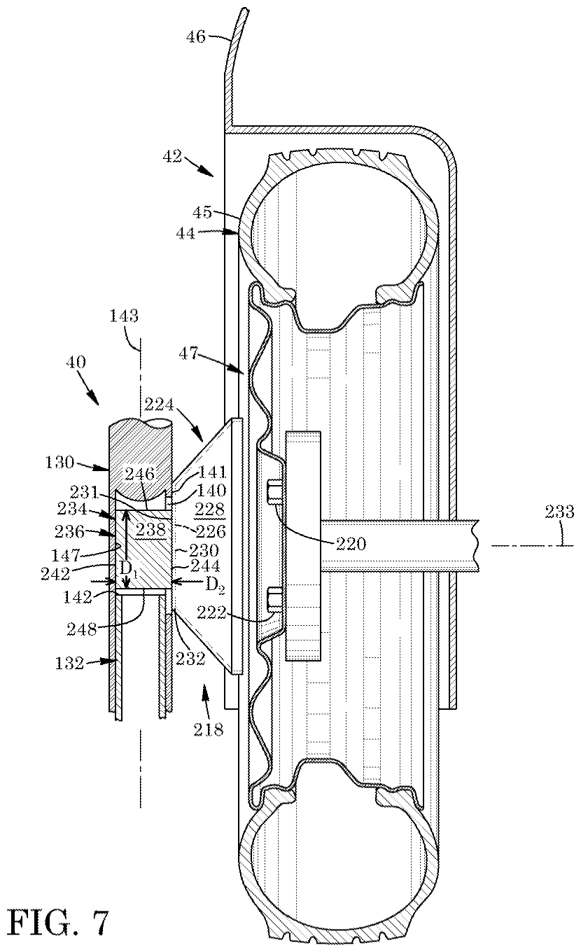

As seen in FIG. 1, wheel immobilizer 40 includes a third elongate telescoping member comprising a fixed elongate member 130 and an adjustable member 132 telescopically received within and adjustable relative to the fixed elongate member. The third elongate telescoping member is angularly spaced from elongate member 48 by an obtuse angle and is angularly spaced from elongate member 54 by an obtuse angle in this example; however, this is not strictly required. The fixed elongate member 130 has an outer end 134 and an inner end 136 coupled to inner ends 50 and 56 of first elongate member 48 and second elongate member 54, in this example via welding 138; however, this is not strictly required. As seen in FIG. 7, fixed elongate member 130 has an opening, in this example a slot 140 positioned between the outer end thereof and the inner end thereof. The slot extends through a first wall 141 of the fixed elongate member. The first wall is planar in this example, though this is not strictly required. Fixed elongate member 130 and adjustable member 132 are tubular in this example and may be referred to as a fixed tubular member and an adjustable tubular member. However, this is not strictly required and the elongate members may have other shaped in other examples. The fixed elongate member and adjustable member extend along a longitudinal axis 143.

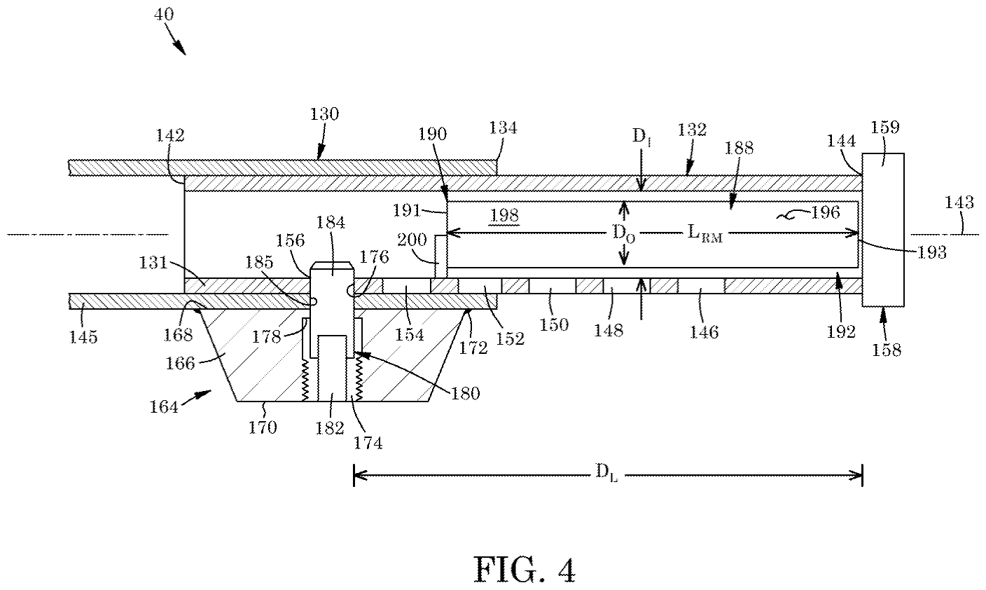

As seen in FIG. 4, adjustable member 132 has an inner end 142 and an outer end 144 spaced-apart from the inner end thereof. As seen in FIG. 1, outer ends 52, 58 and 144 of first elongate member 48, second elongate member 54 and adjustable member 132 are angularly spaced-apart from each other. Referring back to FIG. 4, the adjustable member has a plurality of longitudinally spaced-apart indentations, in this example apertures 146, 148, 150, 152, 154 and 156 extending therein and therealong between inner end 142 thereof and the outer end 144 thereof.

Referring to FIG. 2, wheel immobilizer 40 includes a third C-shaped clasp 158. The third C-shaped clasp includes a first elongate portion 159 which is fixedly coupled to and extends axially outwards from outer end 144 of adjustable member 132, in this example via welding 160; however, this is not strictly required. The third C-shaped clasp may thus be said to telescopically couple to fixed elongate member 130. First elongate portion 59 of third C-shaped clasp 158 extends laterally outwards from axis 143 in this example. The third C-shaped clasp includes a second elongate portion, in this example bent end portion 162 coupled and extending angular outwards from first elongate portion 159 thereof. Portions 159 and 162 of third C-shaped clasp 158 together with adjustable member 132 may thus be said to form a C-shaped member.

Wheel immobilizer 40 includes a locking mechanism 164 to secure the adjustable member 132 relative to fixed elongate member 130. Referring to FIG. 4, the locking mechanism includes a lock housing 166 that is frustoconical in shape in this example; however, this is not strictly required. The lock housing has an inner face 168 and an outer face 170 spaced-apart from the inner face thereof. The inner and outer faces of lock housing 166 are circular in this example, though this is not strictly required. The lock housing tapers in a direction extending from the inner face thereof towards the outer face thereof. Inner face 168 of lock housing 166 couples to second wall 145 of fixed elongate member 130 via welding 172 in this example. The second wall of the fixed elongate member is planar, couples to and extends perpendicular to first wall 141 of the fixed elongate member as seen in FIG. 2 in this example.

Still referring to FIG. 4, the lock housing includes a first opening, in this example a first or outer bore 174 which extends from outer face 170 thereof towards inner face 168 thereof. Lock housing 166 includes a second opening, in this example a second or inner bore 176 which extends from the inner face thereof towards the outer face thereof. Outer bore 174 is coaxially with the inner bore. The outer bore extends radially outwards from the inner bore 176 via shoulder 178.

Locking mechanism 164 includes a lock member, in this example a lock cylinder 180. The lock cylinder has an actuation portion 182 positioned within outer bore 174 of lock housing 166. Lock cylinder 180 includes a projection 184 that extends through inner bore 176 of the lock housing and through a corresponding aperture 185 of fixed elongate member 130.

Still referring to FIG. 4, inner end 142 of adjustable member 132 is inserted within outer end 134 of fixed elongate member 130. The adjustable member is retracted in part within the fixed elongate member until third C-shaped clasp 158 extends over treading 43 and inner side wall 45 of tire 44 seen in FIG. 7. Upon the desired degree of length adjustment being so obtained and referring back to FIG. 4, lock cylinder 180 is activated such that projection 184 extends through aperture 185 of fixed elongate member 130 and engages a corresponding aperture 156 of adjustment member 132. Locking mechanism 164 so actuated functions to inhibit axial movement of the adjustable member relative to the fixed elongate member. The locking mechanism thus selectively fixes positioning of adjustable member 132 relative to fixed elongate member 130. As seen in FIG. 1, locking mechanism 164 includes a key 186 shaped to selectively move lock cylinder 180 from its actuated locked position seen in FIG. 4 to an unlocked position seen in FIG. 1 and vice versa. Projection 184 is spaced-apart from apertures 146, 148, 150, 152, 154 and 156 when the lock cylinder is in the unlocked position and the extent to which adjustable member 132 extends from fixed elongate member 130 is adjustable in the unlocked position.

For storage purposes lock cylinder 180 may be retracted to the unlocked position to remove adjustable member 132 from fixed elongate member 130. Alternatively, the adjustable member may be removed, rotated by 90 degrees, and then reinserted into the fixed elongate member, causing C-shaped clasp 158 to be rotated to lie in plane with first elongate member 48, C-shaped clasp 68, second elongate member 54 and C-shaped clasp 70 as seen in FIG. 9.

Referring to FIG. 4, wheel immobilizer 40 includes an elongate round member 188 which may be tubular or in the form an elongate rod for example. The elongate round member is made of hardened steel in this example to inhibit cutting therethrough; however, this is not strictly required and the elongate round member may be made of materials in other embodiments.

Elongate round member 188 has a first or proximal end portion 190 and a second or distal end portion 192 spaced-apart from the proximal end portion thereof. The elongate round member is positioned within adjustable member 132, with an outer diameter D_{O} that is smaller than inner diameter D_{I} of the adjustable member. Elongate round member 188 extends between locking mechanism 164 and outer end 144 of the adjustment tubular member. Proximal end portion 190 of the elongate round member is positioned at least in part within fixed elongate member 130 in this example. Distal end portion 192 of elongate round member 188 is adjacent to first portion 159 of C-shaped clasp 158 in this example.

The elongate round member has a length L_{RM} between opposite ends 191 and 193 thereof which is less than distance D_{L} between lock cylinder 180 and outer end 144 of adjustable member 132. Elongate round member 188 so shaped is positioned within and freely rotatable relative to the adjustable member.

The elongate round member has an exterior surface 196 configured to promote free rotation thereof within the adjustable member. In this example elongate round member 188 includes a powdered coating 198 with a low coefficient of friction on the exterior surface thereof. The elongate round member may function to rotate upon a thief attempting to cut through adjustable member 132 with an angle grinder for example. Elongate round member 188 is further shaped to generate noise and thus a type of audible alarm when attempting to grind therethrough, further discouraging tampering.

Still referring to FIG. 4, wheel immobilizer 40 includes a retainer member, in this example a retainer pin 200. The pin extends through and couples to wall 131 of adjustment member 132 in this example and is shaped to abut proximal end 191 of the elongate round member 188. Pin 200 is positioned between apertures 152 and 154 in this example. The pin functions to hold elongate round member 188 in place. However, this is not strictly required and the elongate round member may be held in place in other manners in other embodiments or need not be otherwise held in place within adjustable member 132 in other embodiments.

As seen in FIG. 2, wheel immobilizer 40 further includes at least one, in this example a pair of projections 202 and 204. The projections have first or inner ends 206 and 208 coupled to and extending outwards laterally outwards from elongate portions 76 and 159 of C-shaped clasps 68 and 158, respectively. The projections couple to the C-shaped clasps via welding 210 and 212 in this example, though this is not strictly required. Projections 202 and 204 have second or outer ends 214 and 216 spaced-apart from inner ends 206 and 208 thereof. Each projection is planar and an isosceles trapezoid in shape in this example, with the projections tapered in a direction extending from the inner ends thereof to the outer ends thereof. Projections 202 and 204 are made of metal plate in this example and are shaped to inhibit rotation of wheel 42 seen in FIG. 7 when wheel immobilizer 40 is installed and couples to the wheel. The projections are tuned to make noise based in part on selection of the gauge of material and based in part on the manner in which the projections are welded to the C-shaped clasps. The noise emitting therefrom when the projections abut the ground/road may function as a further audible alarm to promote waking up of people in the neighbourhood in which vehicle 46 is parked.

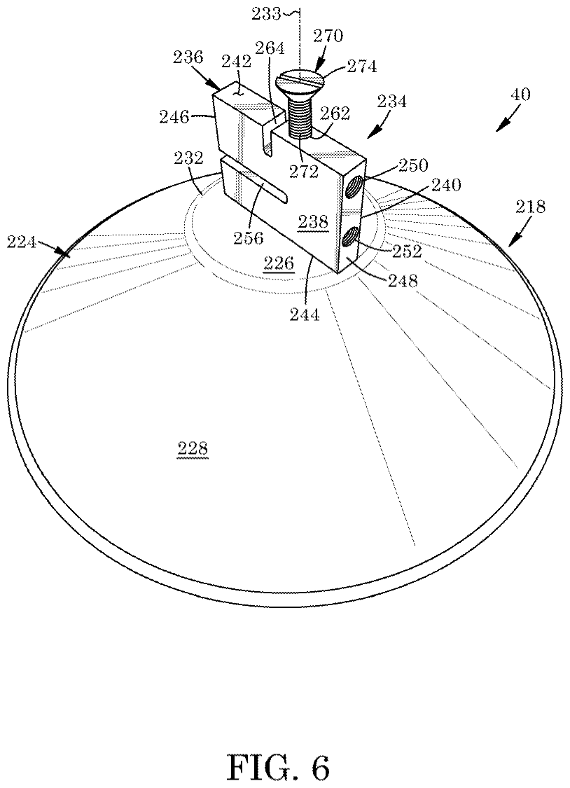

As seen in FIG. 7, wheel immobilizer 40 includes a wheel fastener cover assembly 218 shaped to inhibit access to wheel fasteners 220 and 222 of wheel 42 of vehicle 46 so as to inhibit a wrench or other such tool from removing the same. The wheel fastener cover assembly includes a covering member, in this example a wheel fastener cover 224 shaped to extend about the wheel fasteners. The wheel fastener cover includes a disk 226 that is circular in this example. The disk has a first side 230 and a second side 231 opposite the first side thereof and extends about an axis 233. Wheel fastener cover 224 includes a flange 228 coupled to, extending about, and extending axially outwards from a first side 230 of the disk thereof. In this example the flange couples to and extends radially outwards from a peripheral portion 232 of the disk. As seen in FIG. 6, flange 228 is annular and frustoconical in this example.

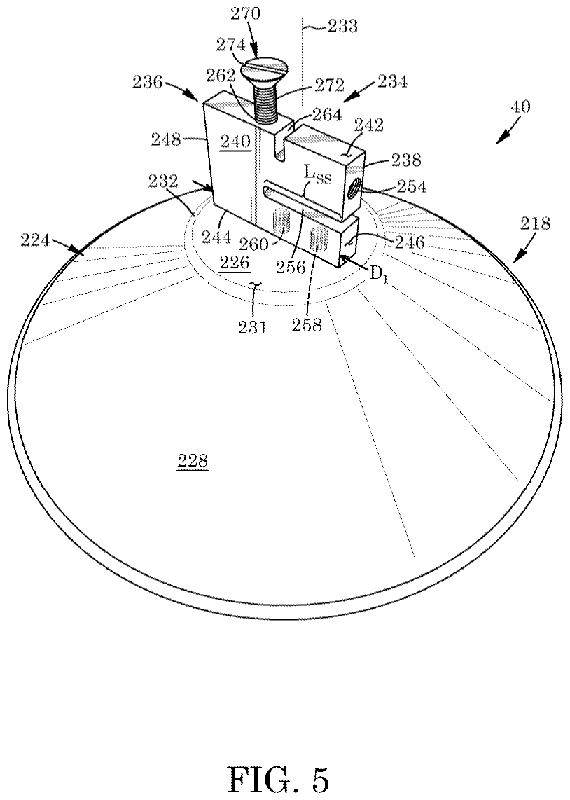

Wheel immobilizer 40 includes a unit connector assembly, in this example a connector block assembly 234. The connector block assembly includes a unit connector or connector block 236. The connector block assembly and connector block may be referred to as an adjustment member or block assembly and adjustment member or block, or a spacer member or block assembly and spacer member or block. Connector block 236 is a rectangular prism in shape in this example. The connector block has a top 238 and a bottom 240 seen in FIG. 5 and spaced-apart from the top thereof.

As seen in FIG. 5, connector block 236 has a first end 242 which in this example is outwardly positioned and a second end 244 spaced-apart from the first end thereof and which in this example inwardly positioned. The connector block has a first side 246 and a second side 248 spaced-apart from the first side thereof. The sides of connector block 236 extend from top 238 thereof to bottom 240 thereof. As seen in FIG. 5, sides 246 and 248 of the connector block are spaced-apart by a first distance D₁. Ends 242 and 244 of connector block 236 extend from top 238 to bottom 240 of the connector block and between sides 246 and 248 of the connector block. Referring to FIG. 7, the ends of connector block 236 are spaced-apart by a second distance D₂ which is less than first distance D₁ in this example.

As seen in FIG. 6, connector block 236 has at least one and in this example first and second threaded apertures 250 and 252 extending into second side 248 thereof and towards first side 246 thereof. The first and second threaded apertures are spaced-apart from each other. First threaded aperture 250 is adjacent to first end 242 of connector block 236 and second threaded aperture 252 is between first end 242 and second end 244 of the connector block in this example. As seen in FIG. 5, the connector block has a third threaded aperture 254 extending into first side 246 thereof and towards second side 248 thereof.

Connector block 236 has a first or side slot 256 which extends from first side 246 thereof and towards second side 248 thereof. The side slot is positioned between ends 242 and 244 of the connector block. Third threaded aperture 254 is positioned between side slot 256 and first end 242 of the connector block in this example. The side slot has a length L_{SS} which is more than half of and in this example approximately ⅔^{rd} the distance D₁ extending between sides 246 and 248 of connector block 236 in this example; however, this is not strictly required and the side slot may have another length in other embodiments.

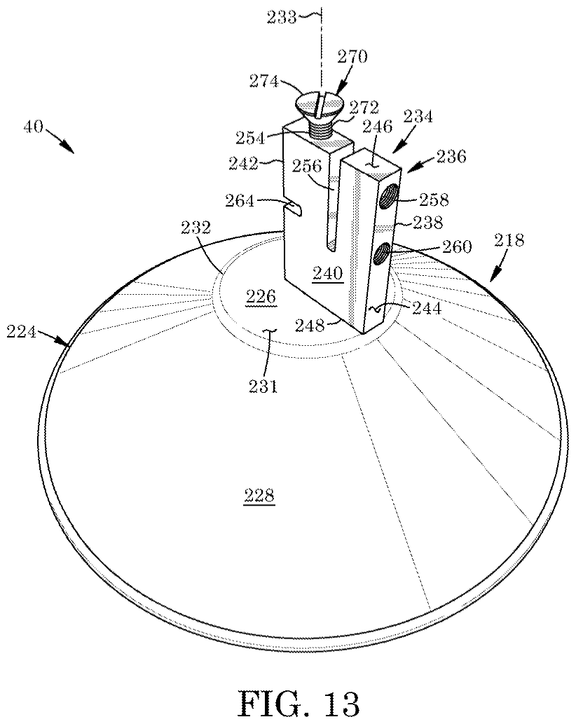

As seen in FIG. 13, the connector block has at least one and in this example fourth and fifth threaded apertures 258 and 260 extending into second end 244 thereof and towards first end 242 thereof. The fourth and fifth threaded apertures are spaced-apart from each other. Fourth threaded aperture 258 is adjacent to first side 246 of connector block 236 and fifth threaded aperture 260 is between the first side and second side 248 of the connector block in this example.

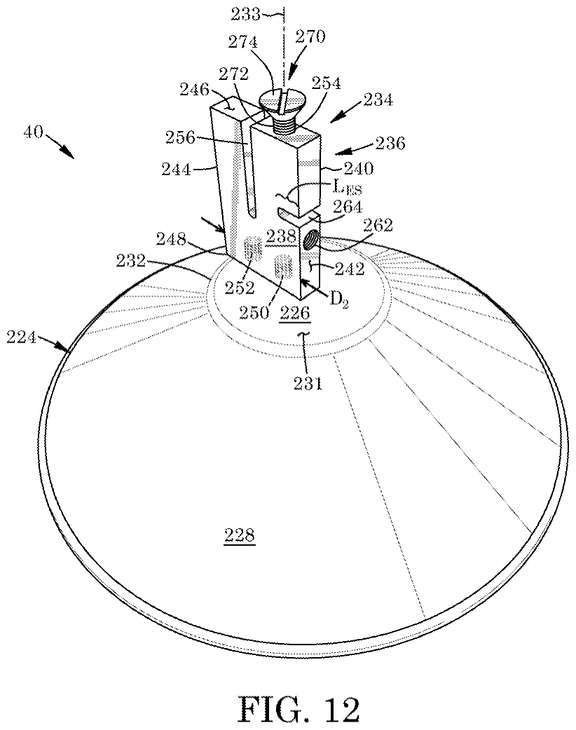

As seen in FIG. 12, the connector block has a sixth threaded aperture 262 in this example extending into first end 242 thereof and towards second end 244 thereof. Connector block 236 has a second or end slot 264 in this example that extends from the first end thereof and towards the second end thereof. Sixth threaded aperture 262 of the connector block is positioned between the end slot and first side 246 of the connector block in this example. End slot 264 is positioned between sides 246 and 248 of the connector block. The end slot has a length L_{ES} which is less than half of and in this example approximately ¼^{th} the distance D₂ extending between ends 242 and 244 of connector block 236 in this example; however, this is not strictly required and the end slot may have another length in other embodiments.

As seen in FIG. 2, connector block assembly 234 includes at least one threaded member, in this example a pair of threaded fasteners, in this case first and second cap screws 266 and 268. The cap screws may be referred to as wheel cover cap screws. First and second cap screws 266 and 268 extend through disk 226 of wheel fastener cover 224 and are threadably received within threaded apertures 258 and 260 seen in FIG. 5 in the configuration of connector block 236 shown in FIG. 5. The cap screws threadably couple the fastener cover to the connector block thereby. Connector block 236 thus selectively couples to disk 226 of wheel fastener cover 224 via first and second cap screws 266 and 268.

Alternatively and referring to FIG. 12, first and second cap screws 266 and 268 may extend through disk 226 of fastener cover 224 and threadably couple connector block 236 via threaded apertures 250 and 252 in the configuration shown in FIG. 12.

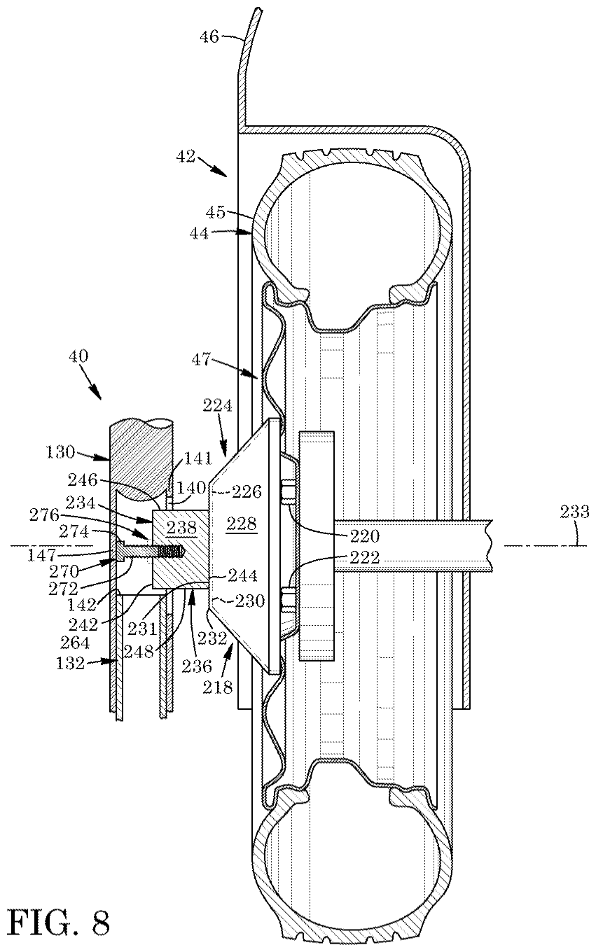

As seen in FIG. 5, connector block assembly 234 includes a threaded member, in this example a threaded fastener, in this case a third cap screw 270. The third cap screw includes a first end portion 272 that is threaded and shaped to selectively threadably couple with aperture 262 in the configuration of connector block 236 seen in FIG. 5. Third cap screw 270 may be referred to as a side cap screw in the configuration of the connector block seen in FIG. 5. The third cap screw includes a second end portion 274 that is enlarged and in the shape of a protuberance in this example. The extent to which third cap screw 270 extends from connector block 236 is adjustable via selective rotation of the second end portion. The third cap screw threadably thus couples to and selectively extends outwards from first side 242 of connector block 236 via aperture 262 in the configuration of the connector block seen in FIG. 5. As seen in FIG. 8, third cap screw 270 is moveable from a retracted position shown in ghost lines and arrow 276, to an extended position shown in solid lines.

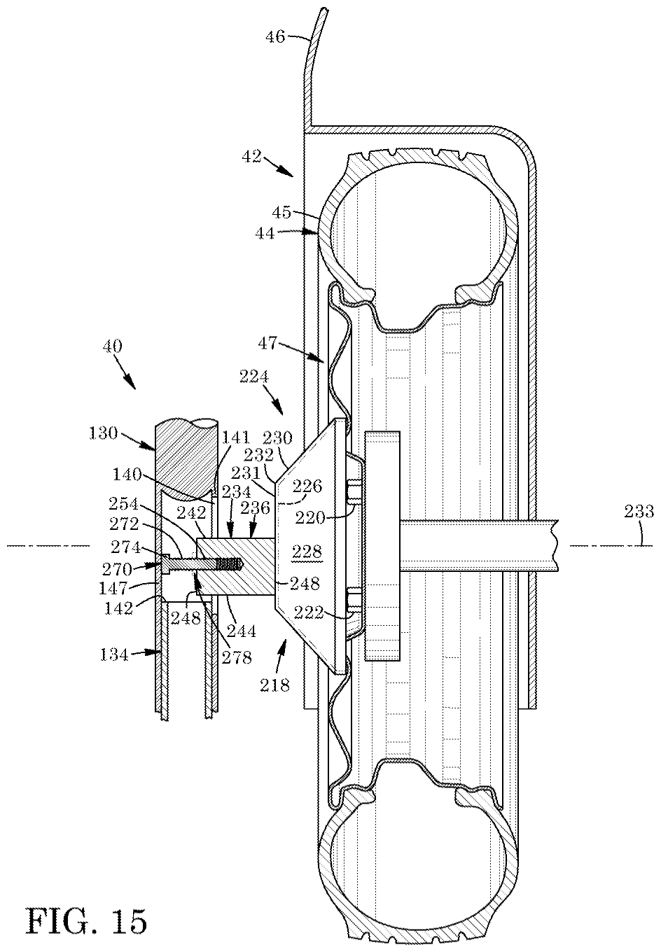

Alternatively and referring to FIG. 12, third cap screw 270 is threadably receivable within threaded aperture 254 in the configuration of connector block 236 seen in FIG. 12. In this configuration, the third cap screw threadably couples to and selectively extends outwards from first end 246 of the connector block via aperture 254. Third cap screw 270 may be referred to as an end cap screw in the configuration of the connector block seen in FIG. 12. As seen in FIG. 15, in this case third cap screw 270 is moveable from a retracted position shown in ghost lines and arrow 278, to an extended position shown in solid lines.

Connector block assembly 234 enables both macro-adjustment and micro-adjustment of the extent to which wheel fastener cover 224 extends from elongate members 48, 54, 130 and 132 seen in FIG. 2. For macro-adjustment, connector block 236 is connectable to the elongate members in either a first, short or lowered position seen in FIGS. 5 to 8, 10 and 11, or a second, tall, or elevated position seen in FIGS. 12 to 17.

Referring to FIG. 5, the lowered position of the connector block is used when the extent to which the wheel fastener cover is spaced from the elongate members must be reduced. In the lowered position, second end 244 of the connector block couples to the wheel fastener cover via first and second cap screws 266 and 268 seen in FIG. 2. Referring back to FIG. 5, the second end of connecting block 236 mounts to second side 231 of disk 226 in this example. Threaded apertures 258 and 260 of connecting block 236 are positioned to ensure that the connecting block is mounted off-center relative to axis 233 of the disk. This may provide additional spacing between connecting block 236 and inner ends 50 and 56 of first elongate member 48 and second elongate member 54 seen in FIG. 1. This may result in a wheel immobilizer that is more flexible in accommodating and selectively coupling to wheels of different shapes and styles.

As seen in FIG. 7, connecting block 236 is shaped to engage with and be at least partially received within slot 140 of fixed elongate member 130 via first end 242 thereof and sides 246 and 248 thereof. The first end of the connector block is shaped to fit within the slot of the fixed elongate member when in the lowered position of the connector block. In the most retracted/lowered position of the connector block seen in FIG. 7, third cap screw 270 seen in FIG. 5 is removed from the connector block and first end 242 of the connector block seen in FIG. 7 extends along and abuts third wall 147 of fixed elongate member 130. FIG. 7 thus shows connector block 236 in a minimum lowered position. Third wall 147 of fixed elongate member 130 is planar in this example. The third wall of the fixed elongate member is spaced-apart from and extends parallel to first wall 141 of the fixed elongate member in this example. Wheel fastener cover 224 so configured and fitted thus couples to elongate members 48, 54, 130 and 132 seen in FIG. 2.

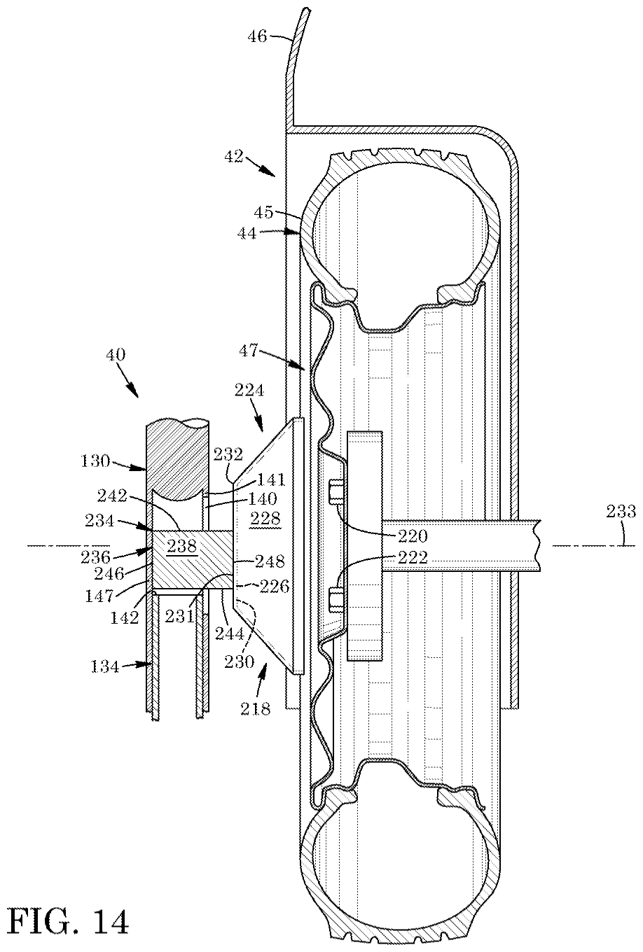

Referring to FIG. 14, the elevated position of connector block 236 is used when the extent to which wheel fastener cover 224 is spaced from elongate members 48, 54, 130 and 132 seen in FIG. 2 must be increased to a large extent relative to the lowered position of the connector block seen in FIG. 7. In the elevated position and as seen in FIG. 12, second side 248 of the connector block couples to disk 226 of wheel fastener cover 224 via first and second cap screws 266 and 268 seen in FIG. 2. Second side 248 of connecting block 236 mounts to second side 231 of the disk in this example. Apertures 250 and 252 of the connecting block are positioned to ensure that the connecting block is mounted off-center relative to axis 233 of disk 226. This may likewise provide additional spacing between connecting block 236 and inner ends 50 and 56 of first elongate member 48 and second elongate member 54 seen in FIG. 2.

As seen in FIG. 14, first side 246 of connector block 236 is shaped to be received within slot 140 of fixed elongate member 130 when in the raised position of the connector block. In the least extended configured of the elevated/raised position of connector block 236 seen in FIG. 14, third cap screw 270 seen in FIG. 12 is removed from the connector block and first side 246 of the connector block seen in FIG. 14 extends along and abuts third wall 147 of fixed elongate member 130. FIG. 14 thus shows connector block 236 in a minimum elevated position.

Micro-adjustment of the extent to which wheel fastener cover 224 extends from elongate members 48, 54, 130 and 132 seen in FIG. 2 and snugly abuts the side of wheel 42 seen in FIG. 8 is enabled via selective threaded adjustment of third cap screw 270 to selectively alter the extent to which second end portion 274 of the cap screw is spaced from connecting block 236. Still referring to FIG. 8, the third cap screw is disposed within slot 140 of fixed elongate member 130 when the connector block is in the lowered position. Third cap screw 270 is adjustable from the retracted position seen in ghost by arrow 276 to the extended position seen in solid lines. Such adjustment causes second end portion 274 thereof to abut third wall 174 of the fixed elongate member and bias wheel fastener cover 224 via connector block 236 to snugly abut wheel 42 and cover wheel fasteners 220 and 222.

Threaded adjustment of third cap screw 270 thus enables micro adjustment of the extent to which wheel fastener cover 224 extends from fixed elongate member 130. The third cap screw as herein described therefore enables further adjustment of the extent to which the wheel fastener cover extends from elongate members 48, 54, 130 and 132 seen in FIG. 2 between the fully lowered position of connector block 236 seen in FIG. 5 and the elevated position of the connector block seen in FIG. 14.

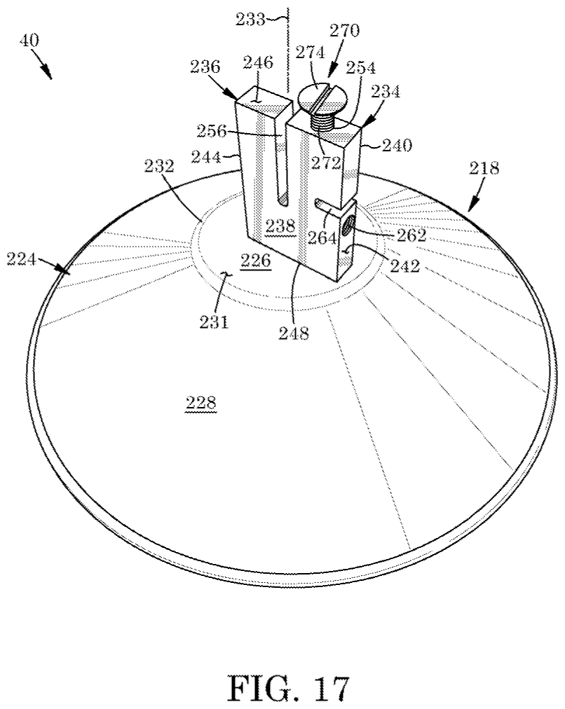

Further micro-adjustment is possible by reversing apertures 258 and 260 with which cap screws 266 and 268 seen in FIG. 2 from the lower position of connector block 236 seen in FIG. 12 to that seen in FIG. 17 which is offset in an axially altered manner.

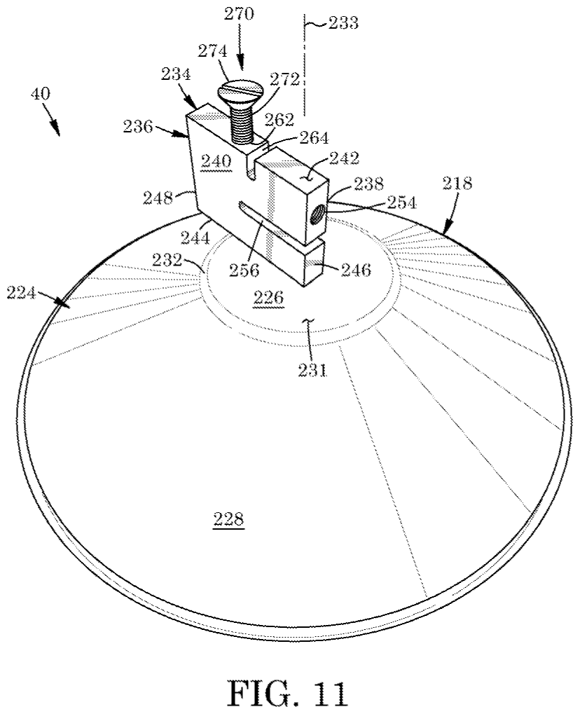

Further micro-adjustment is possible by reversing apertures 258 and 260 with which cap screws 266 and 268 seen in FIG. 2 from the lower position of connector block 236 seen in FIG. 5 to that seen in FIG. 11 which is yet more axially offset.

Referring to FIG. 15, third cap screw 270 is positioned within slot 140 of fixed elongate member 130 when connector block 236 is in the elevated position. The third cap screw enables micro-adjustment of the extent to which wheel fastener cover 224 extends from elongate members 48, 54, 130 and 132 seen in FIG. 2 when the connector block is in the elevated position. Referring back to FIG. 15, third cap screw 270 is adjustable from the retracted position seen in ghost by arrow 278, to the extended position seen in solid lines so as to cause second end portion 274 thereof to abut third wall 147 of fixed elongate member 130 and bias wheel fastener cover 224 via connector block 236 to snugly abut wheel 42 and cover wheel fasteners 220 and 222.

Threaded adjustment of the third cap screw enables micro adjustment of the extent to which the wheel fastener cover extends from the fixed elongate member. Third cap screw 270 thus enables further micro-adjustment of the extent to which wheel fastener cover 224 extends from elongate members 48, 54, 130 and 132 seen in FIG. 2 past the minimum elevated position of the connector block seen in FIG. 14.

Further micro-adjustment is possible by reversing apertures 258 and 260 with which cap screws 266 and 268 seen in FIG. 2 from the lower position of connector block 236 seen in FIG. 12 to that seen in FIG. 17 which is offset in an axially altered manner.

In operation and referring to FIG. 1, C-shaped clasps 68 and 70 are rotated so as to extend perpendicular to their corresponding first and second elongate members 48 and 54. Locking mechanism 164 is actuated to an unlocked position via key 186. Adjustable member 132 is next moved telescopically outwards relative to fixed elongate member 130 so that the adjustable member extends beyond treading 43 of tire 44.

The operator next positions connecting block 236 within slot 140 of fixed elongate member 130 of wheel immobilizer 40 as seen in FIG. 7, for example.

Wheel immobilizer 40 is next mounted to tire 44 of wheel 42 by aligning first elongate member 48 thereof and second elongate member 54 thereof seen in FIG. 1 against front 47 of the wheel. C-shaped clasps 68 and 70 seen in FIG. 2 are positioned to extend across treading 43 of tire 44 seen in FIG. 7, with bent end portions 80 and 82 thereof seen in FIG. 2 extending along inner side walls 45 of the tire seen in FIG. 7. Wheel fastener cover assembly 218 next extends about fasteners 220 and 222 of the wheel seen in FIG. 7. If wheel fastener cover 224 does not quite cover the fasteners, in this case connector block 236 may be re-connected to the wheel cover and third cap screw 270 coupled thereto as described above for further macro and micro adjustments of the cover relative to the wheel fasteners as needed.

Adjustable member 132 is next retracted into fixed elongate member 130 until C-shaped clasp 158 seen in FIG. 2 abuts treading 43 of tire 44 seen in FIG. 7, with bent end portion 162 of the C-shaped clasp seen in FIG. 2 extending along the inner face or side wall 45 of tire 44 seen in FIG. 1. Adjustable member 132 is next moved telescopically outwards relative to fixed elongate member 130 so that the adjustable member extends beyond treading 43 of tire 44 and then retracted inwards so C-shaped clasp 158 extends about and abuts the treading. Locking mechanism 164 is next actuated to the locked position via key 186 to fix positioning of the elongate members 48, 54, 130 and 132 in place about wheel 42. Wheel immobilizer 40, including wheel cover assembly 218, so positioned are inhibited from being removed the wheel thereby.

When trying to rotate wheel 42 with wheel immobilizer 40 so coupled to wheel 42, distal ends 214 and 216 of projections 202 and 204 seen in FIG. 2 are shaped to contact and/or dig into the ground or road. This may result in the projections making a loud and audible sound. In order to further rotate the wheel, the tire and adjacent portion vehicle must pivot about distal ends 214 of projection 202 and 204, hindering further rotation of the wheel thereby.

To remove wheel immobilizer 40, key 186 is used to unlock locking cylinder 180 seen in FIG. 4. This causes projection 184 to retract outwards from aperture 156 and adjustable member 132 is thereafter removable from fixed elongate member 130. C-shaped clasps 68, 70 and 158 seen in FIG. 1 may thereafter be removed from tire 44 and treading 43, with the unit being grasped and moved as a whole.

Connector block assembly 234 seen in FIG. 5 and as herein described may thus further facilitate and enable fitting and abutment of wheel fastener cover 224 of wheel immobilizer 40 against the side wall of a greater variety of wheels and vehicles thereof when the wheel immobilizer is locked in place. The wheel immobilizer as herein described may thus function to further facilitate shallow hub covers, deep hub covers and the like. The central positioning of connector block assembly 234 may result in a doubling of adjustment ability of third elongate member 130 seen in FIG. 1: the regions at which first and second elongate members 48 and 54 with C-shaped clasps 68 and 70 thereof are positioned to extend about the treading and side wall of the wheel may function as a fulcrum with the elongate members comprising a lever extending therefrom to the C-shaped clasp 158 coupled to adjustable member 132.

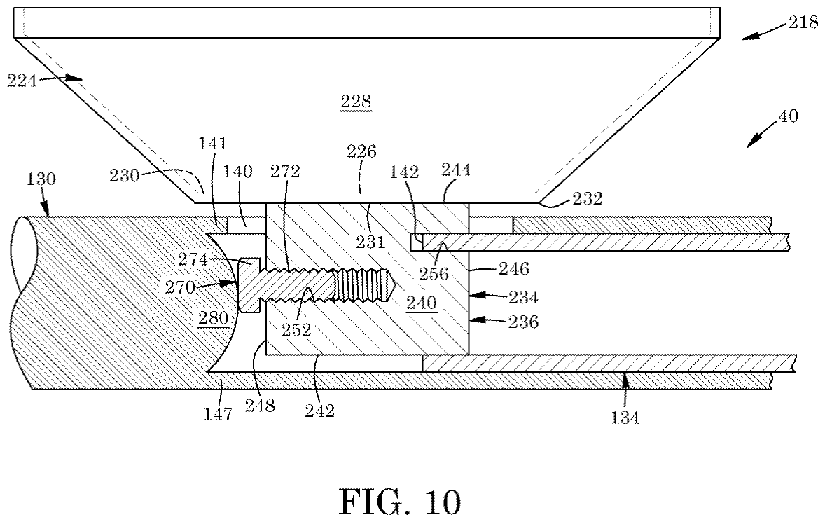

As seen in FIG. 10, if connector block 236 is in the lowered position, side slot 256 in the connector block allows inner end 142 of adjustable member 132 to extend therein when the adjustable member is moved to the storage position seen in FIG. 9. As seen in FIG. 10, third cap screw 270 may be removed from first end 242 of connector block 236 and threadably coupled to aperture 252. The third cap screw may be next rotatably adjusted to further facilitate so as to cause second portion 274 thereof to selectively abut interior portion 280 of fixed elongate member 130 and inner end 142 of adjustable member 132 to be biased against side slot 256, with the various components snugly coupling together. The side slot of the connector block is thus engageable with the fixed elongate member via slot 140 of fixed elongate member 130 for storage purposes when the immobilizer is not in use. Locking mechanism 164 seen in FIG. 1 may then actuated via key 186 to a locked position seen in FIG. 4. This thereby holds wheel fastener cover 224 and connector block 236 seen in FIG. 10 in place and enables each of these components to couple together for easy transport.

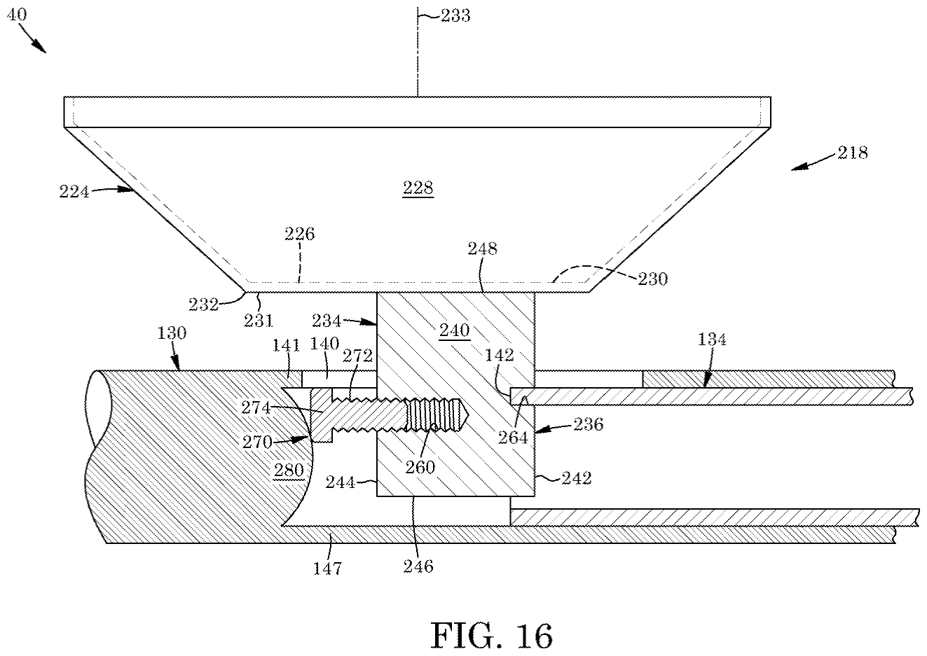

As seen in FIG. 16, if connector block 236 is in the elevated position, end slot 264 in the connector block allows inner end 142 of adjustable member 132 to extend therein when the adjustment is moved to the storage position seen in FIG. 9. Third cap screw 270 may be removed from first side 246 of connector block 236 and threadably coupled to aperture 260. The third cap screw may be next rotatably adjusted to further facilitate so as to cause second portion 274 thereof to selectively abut interior portion 280 of fixed elongate member 130 and inner end 142 of adjustable member 132 to be biased against end slot 264, with the various components snugly coupling together. The end slot of the connector block is thus engageable with the fixed elongate member via slot 140 of fixed elongate member 130 for storage purposes when the immobilizer is not in use. Locking mechanism 164 seen in FIG. 1 may then be actuated via key 186 to a locked position seen in FIG. 4, thereby holding wheel fastener cover 224 and connector block 236 seen in FIG. 10 in place.

Where a component (e.g. an assembly, device, apparatus etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;

in some embodiments the numerical value is in the range of 9.5 to 10.5;

and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).This is the case even if features A and B are illustrated in different drawings and/or mentioned in different paragraphs, sections or sentences.

### Additional Description

Examples of wheel immobilizers have been described. The following clauses are offered as further description.
(1) A wheel immobilizer comprising: a plurality of joined together elongate members with angularly spaced-apart outer ends to which C-shaped clasps couple thereto, with one C-shaped clasp telescopically coupling to one said elongate member and being lockably positioned in place thereafter; a wheel fastener cover shaped to extend about fasteners of a wheel; a connector block having a first end which couples to the wheel fastener cover and a second end shaped to be received within a slot of at least one said elongate member; and a threaded member threadably coupled to the second end of the connector block and disposed within the slot of the at least one said elongate member, whereby threaded adjustment of the threaded member enables adjustment of the extent to which the wheel fastener cover extends from the at least one said elongate member.
(2) The wheel immobilizer of clause 1, or any preceding or subsequent clause, wherein the threaded member is adjustable from a retracted position to an extended position so as to abut an opposite wall of the at least one said elongate member and bias the wheel fastener cover via the connector block to snugly abut the wheel.
(3) A wheel immobilizer comprising: a plurality of joined together elongate members with angularly spaced-apart outer ends to which C-shaped clasps couple thereto, with one C-shaped clasp telescopically coupling to one said elongate member and being lockably positioned in place thereafter; a wheel fastener cover shaped to extend about fasteners of a wheel; a connector block having a pair of sides spaced-apart by a first distance and a pair of ends extending between and perpendicular to said sides, the ends being spaced-apart by a second distance which is smaller than the first distance, whereby when less space is needed between the elongate members and the wheel fastener cover, a first said end of the connector block couples to the wheel fastener cover and a second said end of the connector block is shaped to be received within a slot of at least one said elongate member, and whereby when the extent to which the wheel fastener cover extends from the elongate members needs increasing, a first said side of the connector block couples to the wheel fastener cover and a second said side of the connector block is shaped to be received within the slot of the at least one said elongate member; and a threaded member threadably connectable to one of the ends of the connector block or one of the sides of the connector block, whereby threaded adjustment of the threaded member enables further adjustment of the extent to which the wheel fastener cover extends from the elongate members.
(4) A wheel immobilizer comprising: a plurality of joined together elongate members with angularly spaced-apart outer ends to which C-shaped clasps couple thereto, with one C-shaped clasp telescopically coupling to one said elongate member and being lockably positioned in place thereafter; a wheel fastener cover shaped to extend about fasteners of a wheel; an adjustment block having a first position via which the wheel fastener cover couples to the elongate members and a second position via which the wheel fastener cover couples to the elongate members and extends therefrom to a greater extent than said first position; and a threaded member threadably coupling to the adjustment block and enabling further adjustment of the extent to which the wheel fastener cover extend from the elongate members.
(5) The wheel immobilizer of clause 4, or any preceding or subsequent clause, wherein the adjustment block is a rectangular prism in shape.
(6) The wheel immobilizer of any one of clauses 4 to 5, or any preceding or subsequent clause, wherein the adjustment block is shaped to at least in part fit within a slot of at least one said elongate member when in the first position thereof, and wherein the wheel immobilizer further includes a threaded member threadably coupled to the adjustment block, the threaded member being moveable from a retracted position to an extended position and enabling further micro-adjustment of the extent to which the wheel fastener cover extends from the elongate members when the adjustment block in said first position.
(7) The wheel immobilizer of clause 6, or any preceding or subsequent clause, wherein the adjustment block has an end slot adjacent to the threaded member.
(8) The wheel immobilizer of clause 7, or any preceding or subsequent clause, wherein the end slot of the adjustment block is engageable with the at least one said elongate member via the slot of the at least one said elongate member for storage purposes when the immobilizer is not in use.
(9) The wheel immobilizer of any one of clauses 4 to 8, or any preceding or subsequent clause, wherein the adjustment block has a first side shaped to fit within a slot of at least one said elongate member when in the second position thereof, and wherein the wheel immobilizer further includes a threaded member threadably coupled to the first side of the adjustment block, the threaded member coupled to the first side of the adjustment block being moveable from a retracted position to an extended position and enabling further micro-adjustment of the extent to which the wheel fastener cover extends from the elongate members when the adjustment block is in said second position.
(10) The wheel immobilizer of clause 9, or any preceding or subsequent clause, wherein the adjustment block has a plurality of longitudinally spaced-apart apertures extending into the first side thereof and to which the threaded member is selectively connectable.
(11) The wheel immobilizer of any one of clauses 9 to 10, or any preceding or subsequent clause, wherein the adjustment block has a second side opposite the first side thereof and a side slot which extends from the second side thereof towards the first side thereof.
(12) The wheel immobilizer of clause 11, or any preceding or subsequent clause, wherein the side slot of the adjustment block is engageable with the at least one said elongate member via the slot of the at least one said elongate member for storage purposes when the immobilizer is not in use.
(13) The wheel immobilizer of any one of clauses 1 to 12, or any preceding or subsequent clause, wherein each said threaded member includes a first end portion that is threaded and a second end portion that is protuberance.
(14) The wheel immobilizer of any one of clauses 1 to 13, or any preceding or subsequent clause, wherein each said threaded member is a threaded fastener.
(15) The wheel immobilizer of any one of clauses 1 to 13, or any preceding or subsequent clause, wherein each said threaded member is a cap screw.
(16) A wheel immobilizer comprising: a plurality of joined together elongate members with angularly spaced-apart outer ends to which C-shaped clasps couple thereto, with one C-shaped clasp telescopically coupling to one said elongate member, the elongate members and C-shaped clasps being shaped to partially extend about treading and an inner sidewall of the wheel and lockably positioned in place thereafter; a wheel fastener cover shaped to extend about fasteners of a wheel and couple to the elongate members; and one or more projections coupled to and extend outwards from one or more said C-shaped clasps, the one or more projections inhibiting rotation of the wheel and being tuned to make a noise when rotation of the wheel is attempted.
(17) A wheel immobilizer comprising: a pair of joined together elongate members, with spaced-apart outer ends thereof to which C-shaped clasps couple; a fixed tubular member coupled to and angularly spaced from the elongate members; an adjustment tubular member telescopically received within and adjustable relative to the fixed tubular member and to which a further C-shaped clasp couples via an outer end thereof, with the C-shaped clasps being shaped to partially extend about treading and an inner sidewall of the wheel and be lockable in place thereafter; and an elongate round member positioned within and freely rotatable relative to the adjustment tubular member.
(18) The wheel immobilizer of clause 17, or any preceding or subsequent clause, further including a locking mechanism which selectively fixes positioning of the adjustment tubular member relative to the fixed tubular member, and wherein the elongate round member extends between the locking mechanism and the outer end of the adjustment tubular member.
(19) The wheel immobilizer of any one of clauses 17 to 18, or any preceding or subsequent clause, wherein the elongate round member is an elongate rod.
(20) The wheel immobilizer of any one of clauses 17 to 18, or any preceding or subsequent clause, wherein the elongate round member is tubular.
(21) The wheel immobilizer of any one of clauses 17 to 20, or any preceding or subsequent clause, wherein the elongate round member is configured to inhibit cutting therethrough.
(22) The wheel immobilizer of any one of clauses 17 to 21, or any preceding or subsequent clause, wherein the elongate round member is made of a hardened material.
(23) The wheel immobilizer of any one of clauses 17 to 22, or any preceding or subsequent clause, wherein the elongate round member has a low coefficient of friction on an exterior surface thereof.
(24) The wheel immobilizer of any one of clauses 17 to 22, or any preceding or

subsequent clause, wherein the elongate round member includes a powdered coating with a low coefficient of friction on an exterior surface thereof.
(25) A wheel immobilizer comprising: a pair of joined together elongate members, with spaced-apart outer ends thereof; a pair of C-shaped clasps with respectively cylindrical members coupled thereto and extending outwards therefrom, each said cylindrical member having a radially inwardly extending annular groove and one or more indentations positioned within and extending radially inwards from the annular groove thereof, the outer ends of the elongate members being shaped to receive respective said cylindrical members therein, the elongate members rotatably coupling to the C-shaped clasps via respective detent mechanisms coupled thereto, with balls thereof being spring-biased to extend within the respective said annular grooves and selectively fit respective said indentations to selectively inhibit rotation of the C-shaped clasps relative to the elongate members; a fixed tubular member coupled to and angularly spaced from the elongate members; and an adjustment tubular member telescopically received within and adjustable relative to the fixed tubular member and to which a further C-shaped clasp couples via an outer end thereof, with the C-shaped clasps being shaped to partially extend about treading and an inner sidewall of the wheel and be lockable in place thereafter.
(26) A detent mechanism comprising: a chamber having a primary bore extending from a first end thereof towards a second end thereof, and a second bore extending from the second end thereof towards the first end thereof, the primary bore extending radially outwards from and being in fluid communication with the second bore; an threaded member threadably coupled to the chamber via the primary bore; an end member slidably positioned at least partially within and adjacent to the first end of the chamber; and a resilient member positioned between the threaded member and the end member, whereby the threaded member is externally accessible via the second bore, with adjustment thereof enabling adjustment of the extent to which the resilient member biases the end member outwards from the chamber.
(27) The detent mechanism of clause 26, or any preceding or subsequent clause, wherein the end member is a ball.
(28) The detent mechanism of any of clauses 26 to 27, or any preceding or subsequent clause, wherein the end member is positioned within the primary bore via the first end of the chamber and wherein the second bore has a diameter smaller than that of the end member.
(29) The detent mechanism of any of clauses 26 to 28, or any preceding or subsequent clause, wherein the chamber has an inner wall which extends from the first end thereof towards the second end thereof and which extends about the end member at least in part, the inner wall being smooth and facilitating movement of the end member therealong.
(30) The detent mechanism of clause 29, or any preceding or subsequent clause, wherein the primary bore is threaded between the second bore and the inner wall of the chamber.
(31) The detent mechanism of any of clauses 26 to 30, or any preceding or subsequent clause, wherein the threaded member is a set screw.
(32) The detent mechanism of clause 31, or any preceding or subsequent clause, wherein the set screw includes a socket head facing, in fluid communication with and accessible via the second bore.
(33) In combination, a hollow first elongate member, a second elongate member shaped to fit within and be rotatable relative to the first elongate member, and the detent mechanism of any one of clauses 26 to 32, or any preceding or subsequent clause, the second elongate member having a plurality of circumferentially spaced-apart indentations, the first elongate member having an aperture aligned with the indentations, and the chamber of the detent mechanism coupling to the first elongate member and extending about the aperture such that the end member of the detent mechanism at least partially extends within and engages selective ones of said indentations.
(34) A wheel immobilizer comprising the detent mechanism of any one of clauses 26 to 32, or any preceding or subsequent clause, and/or the combination of the first elongate member, the second elongate member and the detent mechanism of clause 33, or any preceding or subsequent clause.
(35) Apparatus including any new and inventive feature, combination of features, or sub-combination of features as described herein.
(36) Methods including any new and inventive steps, acts, combination of steps and/or acts or sub-combination of steps and/or acts as described herein.

It will be appreciated that many variations are possible within the scope of the invention described herein. It will be understood by someone skilled in the art that many of the details provided above are by way of example only and are not intended to limit the scope of the invention which is to be determined with reference to at least the following claims.

What is claimed is:

1. A wheel immobilizer comprising:
a plurality of joined together elongate members with angularly spaced-apart outer ends to which C-shaped clasps couple thereto, with one C-shaped clasp telescopically coupling to one said elongate member and being lockably positioned in place thereafter;
a wheel fastener cover shaped to extend about fasteners of a wheel; and
an adjustment member via which the wheel fastener cover couples to the elongate members, the adjustment member being shaped to enable one or more of macro and micro adjustments of the extent to which the wheel fastener cover extends from the C-shaped clasps.

2. A wheel immobilizer according to claim 1, wherein the adjustment member has a first position and a second position in which the wheel fastener cover extends outwards from the elongate members to a greater extent than said first position.

3. A wheel immobilizer according to claim 1, wherein the adjustment member is a rectangular prism in shape.

4. A wheel immobilizer according to claim 1, wherein the adjustment member has a pair of ends, at least one threaded aperture extending into each respective said end thereof, a pair of sides extending between the ends thereof, and at least one threaded aperture extending into each respective said side thereof.

5. A wheel immobilizer according to claim 1, including a threaded member threadably coupling to the adjustment member and enabling further adjustment of the extent to which the wheel fastener cover extend from the elongate members.

6. The wheel immobilizer as claimed in claim 5, wherein the threaded member is adjustable from a retracted position to an extended position so as to abut an opposite wall of the at least one said elongate member and bias the wheel fastener cover via the adjustment member to snugly abut the wheel.

7. A wheel immobilizer according to claim 5, wherein the threaded member includes a first end portion that is threaded and a second end portion that is enlarged and planar at least in part.

8. A wheel immobilizer according to claim 1, wherein the adjustment member has at least one threaded aperture along an end thereof and at least one threaded aperture along a side thereof, and wherein the wheel immobilizer includes a threaded member threadably connectable to one of the ends or sides of the adjustment member, whereby threaded adjustment of the threaded member enables further adjustment of the extent to which the wheel fastener cover extends from the elongate members.

9. A wheel immobilizer according to claim 1, wherein the adjustment member has a first end which couples to the wheel fastener cover and a second end shaped to be received within a slot of at least one said elongate member, and wherein the wheel immobilizer includes a threaded member threadably coupled to the second end of the adjustment member and disposed within the slot of the at least one said elongate member, whereby threaded adjustment of the threaded member enables adjustment of the extent to which the wheel fastener cover extends from the at least one said elongate member.

10. A wheel immobilizer according to claim 1, wherein the adjustment member has a pair of sides spaced-apart by a first distance and a pair of ends extending between and perpendicular to said sides thereof, the ends of the adjustment member being spaced-apart by a second distance which is smaller than the first distance, whereby when less space is needed between the elongate members and the wheel fastener cover, a first said end of the adjustment member couples to the wheel fastener cover and a second said end of the adjustment member is shaped to be received within a slot of at least one said elongate member, and whereby when the extent to which the wheel fastener cover extends from the elongate members needs increasing, a first said side of the adjustment member couples to the wheel fastener cover and a second said side of the adjustment member is shaped to be received within the slot of the at least one said elongate member.

11. A wheel immobilizer according to claim 1, wherein the adjustment member has at least one slot extending through at least one of the ends or sides thereof, the adjustment member being engageable with at least one said elongate member via said slot for storage purposes when the immobilizer is not in use.

12. A wheel immobilizer according to claim 1, including one or more projections coupled to and extend outwards from one or more said C-shaped clasps, the one or more projections inhibiting rotation of the wheel and being tuned to make one or more screeching noises upon contacting a hard surface that the wheel abuts.

13. A wheel immobilizer comprising:
a plurality of joined together elongate members with angularly spaced-apart outer ends to which C-shaped clasps couple thereto, with one said elongate member comprising a fixed tubular member and an adjustable tubular member telescopically coupling thereto and being lockably positioned in place thereafter, the adjustable tubular member being non-rotatable relative to the fixed tubular member; and
at least one an elongate round member positioned within and freely rotatable relative to at least one of the elongate members.

14. A wheel immobilizer according to claim 13, wherein the elongate round member is configured to inhibit cutting therethrough and is at least one of tubular and an elongate rod.

15. A wheel immobilizer according to claim 13, including a locking mechanism which selectively fixes positioning of the adjustment tubular member relative to the fixed tubular member, and wherein the elongate round member extends between the locking mechanism and an outer end of the adjustment tubular member.

16. A wheel immobilizer according to claim 13, including one or more of: the elongate round member is made of a hardened material; the elongate round member is has a low coefficient of friction on an exterior surface thereof; and the elongate round member is shaped to generate noise when attempting to cut therethrough.

17. A wheel immobilizer comprising:
a plurality of joined together elongate members with angularly spaced-apart outer ends;
at least one C-shaped clasp rotatably received within an outer end of a corresponding said elongate member via an end protrusion, said end protrusion having a radially inwardly extending annular groove and one or more circumferentially spaced-apart indentations positioned within and extending radially inwards from the annular groove thereof; and
at least one detent mechanism via which the corresponding said elongate member rotatably couples to the at least one said C-shaped clasp, the at least one detent mechanism including an end member spring-biased to extend within the annular groove and respective ones of said indentations to selectively inhibit rotation of the at least one said C-shaped clasp relative to the corresponding elongate member.

18. A detent mechanism according to claim 17, the detent mechanism comprising:
a chamber having a primary bore extending from a first end thereof towards a second end thereof, and a second bore extending from the second end thereof towards the first end thereof, the primary bore extending radially outwards from and being in fluid communication with the second bore;
a threaded member threadably coupled to the chamber via the primary bore;
an end member slidably positioned at least partially within and adjacent to the first end of the chamber; and
a resilient member positioned between the threaded member and the end member, whereby the threaded member is externally accessible via the second bore, with adjustment of the threaded member enabling adjustment of the extent to which the resilient member biases the end member outwards from the chamber.

19. A detent mechanism as claimed in claim 18, wherein the threaded member is a set screw with a socket head facing, in fluid communication with and accessible via the second bore.

20. In combination, a hollow first elongate member, a second elongate member shaped to fit within and be rotatable relative to the first elongate member, and the detent mechanism as claimed in claim 18, the second elongate member having a plurality of circumferentially spaced-apart indentations, the first elongate member having an aperture aligned with the indentations, and the chamber of the detent mechanism coupling to the first elongate member and extending about the aperture such that the end member of the detent mechanism at least partially extends within and engages selective ones of said indentations.
